(19) United States
(12) Patent Application Publication
(10) Pub. No.: US 2011/0273731 A1
(43) Pub. Date: Nov. 10, 2011

(54) PRINTER WITH ATTENTION BASED IMAGE CUSTOMIZATION

(75) Inventors: John S. Haikin, Fremont, CA (US); Francisco Imai, Mountain View, CA (US)

(73) Assignee: CANON KABUSHIKI KAISHA, Tokyo (JP)

(21) Appl. No.: 12/977,846

(22) Filed: Dec. 23, 2010

Related U.S. Application Data
(63) Continuation-in-part of application No. 12/776,842, filed on May 10, 2010.

(51) Int. Cl. G06F 15/00; G06F 3/033

(52) U.S. Cl. 358/1.9; 345/158

(57) ABSTRACT

An image selected to be printed is rendered for display, prior to printing, based on the relative position and orientation of a display in relation to a user's head, where the displayed rendered image is a representation of what the rendered image will look like when printed. The user's eye movement relative to the rendered image is tracked, with at least one area of interest in the image to the viewer being determined based on the viewer's eye movement, an imaging property of the at least one area of interest is adjusted, the image to be printed is rendered based on adjusting the imaging property, and the image is printed.

### CROSS-REFERENCE TO RELATED APPLICATIONS

This application is a continuation in-part of U.S. patent application Ser. No. 12/776,842, filed May 10, 2010, the entire disclosure of which is hereby incorporated by reference and to which the benefit of the earlier filing data for the common matter is claimed.

### BACKGROUND OF THE INVENTION

1. Field of the Invention

Aspects of the present invention relate to an image forming apparatus and method for the adjustment and customization of an image prior to printing the image.

2. Description of the Related Art

Currently available image forming apparatuses, such as inkjet printers, multifunction devices (hereinafter referred to as “MFP”), etc, enable users to import photographic images directly to the image forming apparatus without the need for a computer being connected to the image forming apparatus. Users are able to import photographic images from such devices as digital cameras or portable/removable storage devices, e.g., USB flash drive, SD card, CF card, etc., These types of image forming apparatuses typically include a built-in display that allow a user to preview one or more of the imported photographic images prior to printing a particular image(s).

The built-in displays on current image forming apparatuses are not currently seen to be using the potentials provided by computational photography imagery to customize the rendering of the image for printing. More specifically, they are not seen to take advantage of the added dimensionality provided by computational photography. Also, currently built-in-displays show only the original image and not a representation of what the image will look like when it is be printed.

Computational photography is an increasing area of interest in the field of digital photography. Computational photography generally encompasses photographic and/or computational techniques that extend beyond the limitations of traditional photography, to provide images and/or image data that typically could not be otherwise obtained with conventional techniques. For example, computational photography may be capable of providing images having unbounded dynamic range, variable focus, resolution, and depth of field, as well as image data with hints about shape, reflectance and lighting.

While traditional film and/or digital photography provides images that represent a view of a scene via a 2D array of pixels, computational photography methods may be capable of providing a higher-dimensional representation of the scene, such as for example by capturing extended depth of field information in the form of light fields. The extended depth of field information can subsequently be used to refocus an image in focal planes selected by a user, such as for example to selectively bring background and/or foreground objects present in the scene into focus.

An example of a technique that refocuses a portion of a digital photographic image in focal planes selected by a user is described in U.S. Pat. No. Application Publication No. 2008/0131019 to Ng, published Jun. 5, 2008. In the technique according to Ng, a set of images is computed corresponding to digital photographic images and focused at different depths. Refocus depths for at least a subset of the pixels are identified and stored in a look-up table, such that the digital photographic image can be refocused at a desired refocus depth determined from the look up table. Selection of the desired refocus depth is achieved by having a user gesture to select a region of interest displayed on a screen, such as by clicking and dragging a cursor on the screen via a mouse or other pointing device.

Yet another trend in digital imaging is the capturing and integration of multiple different views of a scene into multi-dimensional image data, which data can be used to provide multiple points of view of the scene. The multiple views used as the basis for the multidimensional data can be obtained using computational photography and/or conventional photography techniques. For example, the multi-dimensional image data can be obtained using computational photography techniques that capture lightfield images of the full 4D radiance of a scene, which lightfield images may be used to reconstruct correct perspective images for multiple viewpoints. Techniques for obtaining the multi-dimensional data can also include re-construction of scenes using 3D modeling of multiple images. For example, a database of photos may be used to compute a viewpoint for each photo of a particular scene, from which a viewable 3D model of the scene may be reconstructed.

However, it has been a challenge to provide an intuitive and user-friendly rendering of the multi-dimensional data generated by such techniques on a conventional display. That is, while computational photographic techniques and/or the integration of multiple views of a scene can provide image data with multiple layers of information, it can be difficult for the user to access and view this information in a way that is both intuitive and meaningful to the user.

One technique that has recently been developed to assist in the viewing of multi-dimensional virtual images is a view-dependent rendering technique, which allows the perspective of a virtual image to be changed according to changes in display orientation in relation to a position of the viewer. A method of implementing such view dependent rendering is described, for example, in the article The tangiBook: A Tangible Display System for Direct Interaction with Virtual Surfaces” by Darling et al., 17^{th} Color Imaging Conference Final Program and Proceedings, 2009, pages 260-266. According to this method, the relative position and orientation of a display in relation to a user's head is measured, and then the virtual image is rendered with a perspective and lighting that corresponds thereto. The result is that the virtual surfaces are rendered on the display in such a way that they can be observed and manipulated in a manner similar to that of real surfaces. For example, “tilting” of the display may make it appear as if the virtual image is being viewed from above or below, and/or changing of the position of the user's head with respect to the display changes the lighting environment on the virtual image.

However, while such view-dependent rendering techniques have been used to facilitate viewing of computer-generated virtual models, they generally have not been deemed suitable for the rendering of images captured from real scenes. This is at least in part due to the fact that changing the perspective of real images while viewing with a view-dependent rendering technique can cause a loss in the proper focus of the image. Also, the amount of image data captured by computational photography systems and other multidimensional techniques can make view-dependent rendering of the image data associated with a real scene both prohibitively expensive and time consuming. Furthermore, techniques such as the image-refocusing method described by Ng are generally not suitable for use with view-dependent rendering systems, because the requirement that the user select the area of interest via gesturing does not allow for the fast refocus response time needed for seamless viewing of an image with view-dependent rendering.

In light of the above, there remains a need for a method and apparatus that allows for view-dependent rendering of multidimensional image data in order for a user to customize rendering of an image to be printed.

### SUMMARY OF THE INVENTION

According to an aspect of the invention, a method for printing an image includes selecting an image to be printed, determining a relative position and orientation of a display in relation to a user's head, rendering the selected image for display based on the relative position and orientation, displaying the rendered image wherein the displayed rendered image is a representation of what the rendered image will look like when printed, tracking the user's eye movement relative to the rendered image, determining at least one area of interest in the image to the user based on the user's eye movement, adjusting at least one imaging property of the at least one area of interest, rendering an image for printing based on adjusting the at least one imaging property, and printing the image.

### BRIEF DESCRIPTION OF THE DRAWINGS

FIG. 1 is a diagram illustrating an apparatus having a display configured to provide view-dependent rendering of the image with adjustment of an imaging property, according to an embodiment of the invention.

FIG. 2 is a flow diagram illustrating a method of displaying a soft proof of an image and printing an image according to an embodiment of the invention.

FIG. 3 is a flow chart illustrating a method for displaying a soft proof of an image in a view-dependent manner with adjustment of an imaging property and printing the image according to an embodiment of the invention.

FIGS. 4A-4B are diagrams illustrating aspects of the determination of the relative position and orientation of the display in relation to a viewer's head, according to an embodiment of the invention.

FIGS. 5A-5C are diagrams illustrating another aspect of the determination of the relative position and orientation of the display in relation to the viewer's head, according to an embodiment of the invention.

FIGS. 6A-6C are diagrams illustrating aspects of tracking a viewer's eye movement relative to a displayed image, and determining at least one area of interest in the image, according to an embodiment of the invention.

FIGS. 7A-7B are diagrams illustrating aspects of adjusting an imaging parameter corresponding to the focus of at least one area of interest in a displayed image, according to an embodiment of the invention.

FIG. 8 is a flow diagram illustrating a method of displaying a soft proof image on a display in a view-dependent manner and adjusting an imaging parameter corresponding to a focus of at least one area of interest in the displayed soft proof image, according to an embodiment of the invention.

FIG. 9 is a flow diagram illustrating a method of storing parameters and/or properties for rendering a display of an image according to a selected view, according to an embodiment of the invention.

FIGS. 10A-10B are block diagrams illustrating display control units for rendering an image on a display in a view-dependent manner with adjustment of an imaging property, and for storing parameters and/or properties for rendering a display of an image according to a selected view, according to embodiments of the invention.

FIG. 11 is a block diagram of an internal architecture of an apparatus having the display control units of FIGS. 10A-10B, for rendering an image on a display in a view-dependent manner with adjustment of an imaging property and printing the image, according to an embodiment of the invention.

### DESCRIPTION OF THE EMBODIMENTS

Embodiments of the present invention provide for view-dependent rendering of multidimensional image data where the image is displayed as a representation of how the image would appear when printed, thereby customizing and enhancing a print of the image. Aspects of the invention may be applicable, for example, to the rendering and printing of image data obtained by computational photography methods, such as image data corresponding to captured light field images.

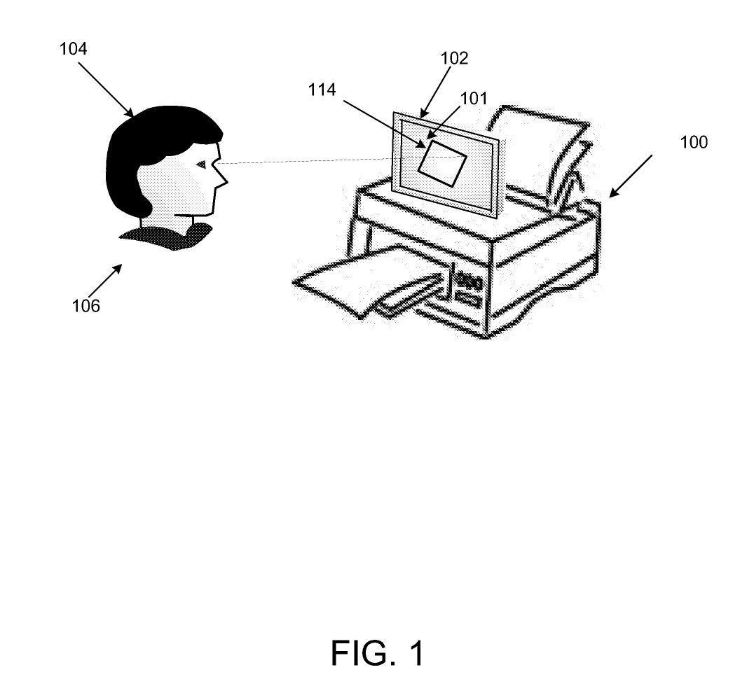

Pursuant to these embodiments, an apparatus 100 comprising a display 102 may be provided for displaying thereon the view dependent rendering of a representational version of how the image would appear when printed, as shown for example in FIG. 1. Hereinafter, displaying a representational version of the image as it would it appear when printed will be referred to as “soft proofing” the image and the displayed image will be referred to as a “soft proof image. The display 102 may comprise, for example, one or more of an LCD, plasma, OLED and CRT, and/or other type of display that is capable of rendering an image thereon based on image data. In the embodiment as shown in FIG. 1, the apparatus 100 comprises a multifunction peripheral (hereinafter referred to as an MFP), which includes, but is not limited, to such functions as printing, scanning, copying, and faxing. As illustrated in FIG. 1, the display 102 is incorporated within the MFP 100, however, aspects of the invention are not limited to this embodiment, and other devices and/or combinations of devices may also be provided. For example, the display 102 may be a separate apparatus connected to the MFP 100 via a wired, wireless interface, or any other type of communication connection.

According to aspects of the invention, a soft proof image is rendered on the display 102 in a view-dependent manner, such that a change in the position and/or orientation of the display 102 in relation to a viewer 106, for example by tilting of the display 102, and/or movement of a viewer's head 104 in front of the display screen 101, results in realistic-appearing changes in the surface lighting and material appearance of the soft proof image displayed on the display 102. The view-dependent rendering can thus give the effect that virtual surfaces in the image can be viewed and manipulated in manner similarly to real ones, by allowing the surfaces in the soft proof image, which may be illuminated by environment-mapped lighting, to be interactively updated in real time according to changes in the display orientation and/or position in relation to the viewer 106.

An example of a method used to provide a view-dependent rendering of a computer-generated image is described in the article entitled “The tangiBook: A Tangible Display System for Direct Interaction with Virtual Surfaces” by Darling et al., as published in the 17^{th} Color Imaging Conference Final Program and Proceedings for the Society for Imaging Science and Technology, 2009, pages 260-266, which reference is hereby incorporated by reference in its entirety. However, aspects of the invention are not limited to the method as described in this article, and other view-dependent rendering methods that provide for a change in the virtual perspective and/or illumination of a displayed image according to a change in the relative position and/or orientation of the display 102, may also be used.

Aspects of the invention further provide for the selective adjustment of at least one imaging property in the view-dependently rendered soft proof image. In particular, aspects of the invention provide for adjustment of an imaging property in an area 114 that is determined to be of interest to the viewer 106, such as an area 114 in the soft proof image at which it is determined that the viewer 106 is gazing, as shown for example in FIG. 1.

The adjustment of the imaging property may serve to enhance the experience of printing the view-dependently rendered soft proof image by providing a relatively intuitive means for a viewer 106 to interactively adjust one or more imaging parameters in an area of the soft proof image that is of interest of the viewer 106, such as to enhance and/or refine imaging properties of the soft proof image in the particular area 114, while also reducing the computational effort required for rendering of the full soft proof image in a view-dependent manner. For example, according to one aspect, the viewer 106 may be able to automatically adjust an imaging property of an area of interest 114 simply by gazing at the particular area 114, substantially without requiring the adjustment of the same imaging property in other areas of the soft proof image that are outside the particular area of interest 114.

According to aspects of the invention, the adjustment of the imaging property in the area of interest 114 may comprise at least one of an adjustment of the imaging property to a predetermined level, such as a level pre-stored in a storage medium of the apparatus 100, and/or an adjustment calculated by the apparatus 100 at the time of viewing. According to one aspect, it may be possible to continuously adjust the imaging property according to factors such as a duration of view, the number of view times of the particular area of interest by the viewer 106, and the like. It may also be the case that a plurality of imaging properties are adjusted for a particular area of interest 114, and/or different imaging properties may be adjusted for different areas of interest. It may also be possible for a viewer 106 to switch between imaging parameters for adjustment thereof, for example by inputting or otherwise selecting from among available imaging parameters via a viewer interface provided as a part of the apparatus 100.

According to aspects of the invention, examples of imaging properties that may be adjusted may include, but are not limited to, at least one of the focus, sharpness, white balance, dynamic range, resolution, brightness and tone mapping of the area of interest 114. However, it should be understood that aspects of the invention are not limited to the adjustment of these particular imaging properties, and the adjustment of imaging properties other than those particularly described herein may also be performed.

In one embodiment, aspects of the invention may be suitable for displaying a soft proof of image data that has been obtained using computational photography methods. Suitable computational photography techniques may include both advanced image-capturing techniques as well as, and/or alternatively, advanced image processing techniques, which can be used to create image data having enhanced information. The computational photography methods can include methods that obtain multiple different values for one or more imaging parameters for a given scene in a single captured image, as well as methods that capture multiple images of a scene with different parameters, and/or that process and combine image data from multiple images, to derive new information and/or images therefrom, among other techniques.

For example, the image data may be prepared according to computational photography methods that provide multidimensional information about an imaged scene, such as methods using image data corresponding to captured light fields containing extended depth of field information. The image data used according to aspects of the invention may comprise, for example, at least one of data of a real scene captured by an image capturing device, a computer-generated image, and a combination of a real scene and a computer-generated image. Further examples of suitable computational photography methods according to aspects of the invention are described below. In addition, while embodiments of particular computational photography techniques used to prepare image data are described herein, the image data according to aspects of the invention may also be obtained by other computational photography techniques and/or other image-generation methods other than those specifically described herein.

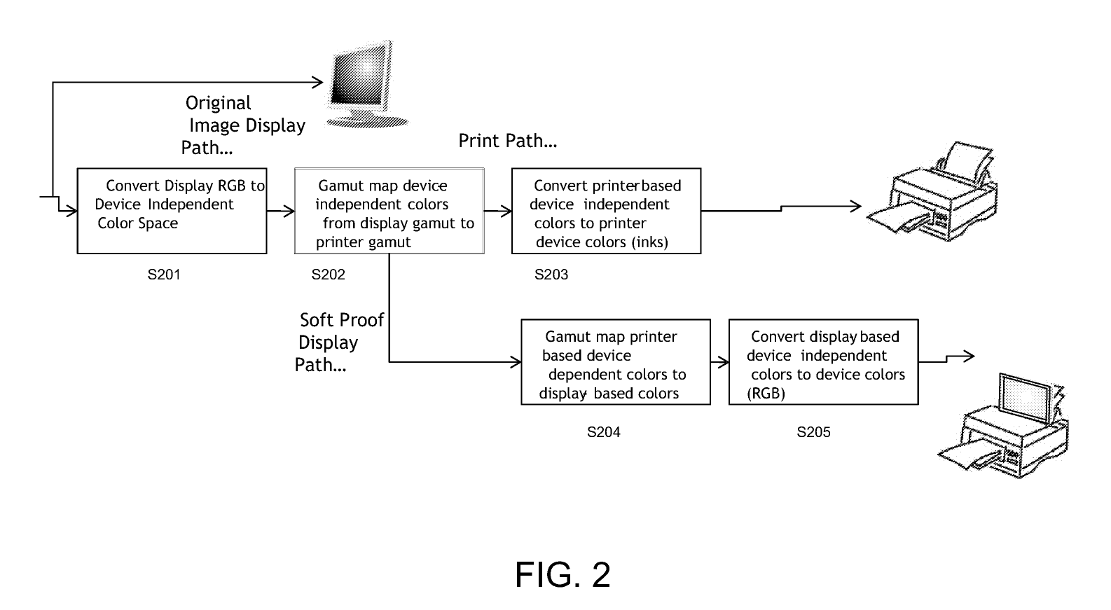

Aspects of the invention are further described with reference to FIG. 2, which is a flow chart illustrating an embodiment of a method for displaying a soft proof image on display 102 and printing the image. According to the present embodiment, in step S201, image data is converted from display RGB to a device independent color space. The method(s) for performing this conversion is well known in the art, and thus a detailed description is omitted herein. Next, in step S202, the device independent colors are gamut mapped from a display gamut to a printer gamut. The method for performing this process is well known in the art, and thus a detailed description is omitted herein. Following step S203, the flow splits into a print path and into a soft proof display path.

In the print path, following the gamut mapping of the device independent colors from a display gamut to a printer gamut (step S202), in step S203, the printer based device independent colors are converted to printer device colors, i.e., ink colors of the particular printer. This conversion is well known in the art, and thus a detailed description is omitted herein. Following the conversion to printer device colors, the image is printed.

In the soft proof display path, following the gamut mapping of the device independent colors from a display gamut to a printer gamut (step S202), in step S204, the printer based device dependent colors are gamut mapped to display based colors. The process for performing this gamut mapping is well known in the art, and thus a detailed description is omitted herein.

Next, in step S205, the display based colors are converted to device to device colors (RGB). Conversion of the display based colors to device colors is well known in the art, and thus a detailed description is omitted herein. Following the conversion to device colors (RGB), a soft proof image is displayed.

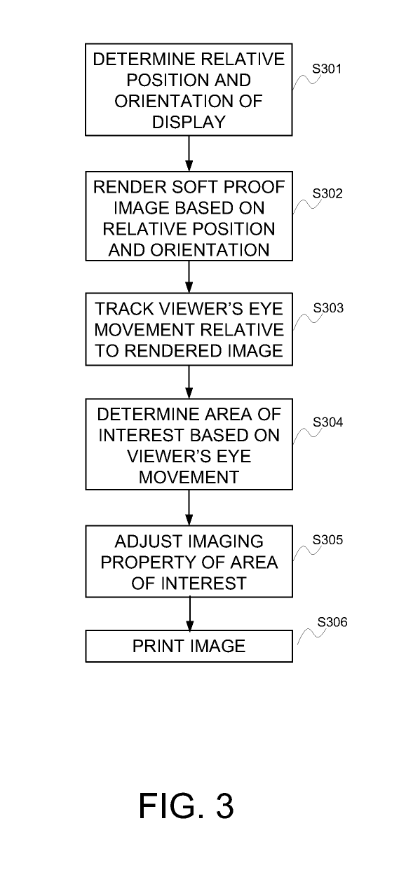

FIG. 3 is a flow chart showing an embodiment of a method for displaying a soft proof image in a view-dependent manner, with adjustment of an imaging property in the area 114 that is determined to be of interest to the viewer 106, and then printing the image. In a first step according to this embodiment (step S301), a relative position and orientation of the display 102 in relation to a viewer's head 104 is determined. Following this step, a soft proof of an image is rendered on the display 102, as described above, based on the relative position and orientation determined in step S301 (step S302). The soft proof image thus displayed corresponds to a view-dependent rendering of the soft proof image, for which the perspective and/or illumination of the soft proof image is rendered according to a position and/or orientation of the display 102 with respect to the viewer 106.

Once the view-dependent rendering is displayed, the viewer's eye movement relative to the rendered soft proof image is tracked on the display screen (step S303). At least one area of interest in the image to the viewer 106 is determined based on the viewer's eye movement (step S304). The imaging property of the at least one area of interest determined in step S304 is then adjusted (step S305). Once the viewer is satisfied with the soft proof image, the image is printed in step S306.

Any one or more of the steps S301-S305 may be repeated to provide continuous updating and/or re-adjusting of the soft proof image according to a change in relative position and/or orientation of the display 102 with respect to the viewer 106, as well as according to any change in the area of interest 114 in the soft proof image being gazed at by the viewer 106. A description of each of these steps is provided in further detail below.

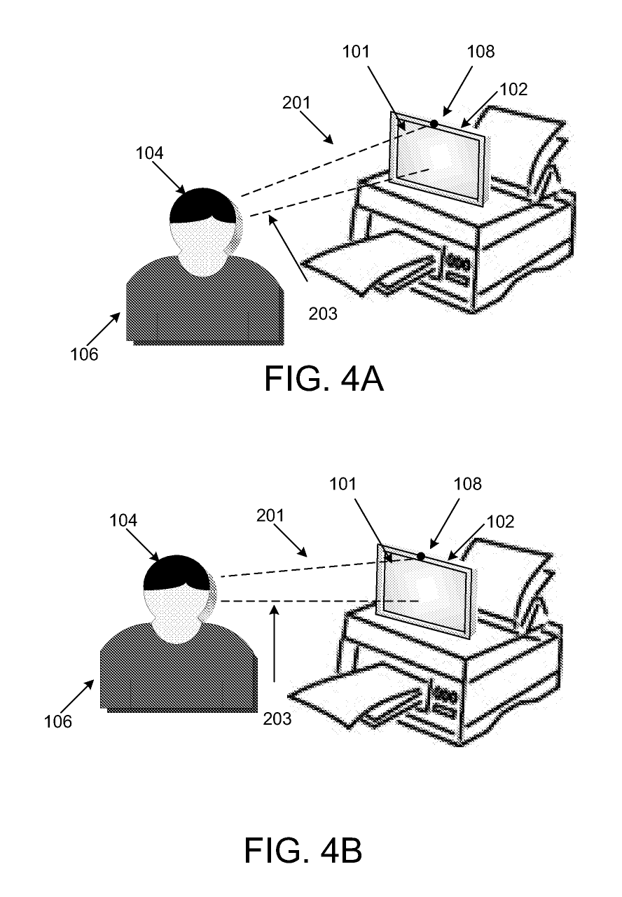

The determination of the relative position and orientation of the display 102 in relation to the viewer's head 104, as in step S301, can be achieved via techniques that allow for determination of position information relating to the viewer 106 and the display 102, as well as orientation information relating thereto. For example, according to one embodiment of the invention, the relative position and orientation may be determined by tracking a position of the viewer's head 104, for example via a camera 108 (e.g., as shown in FIG. 4A) or other image tracking device, to obtain head position coordinates, while also providing a position and/or orientation measuring sensor 110 (e.g., as shown in FIG. 4) that is capable of measuring the position and/or orientation of the display 102, to provide display coordinates. The coordinates thus determined for both the viewer's head 104 and the display 102 may then be correlated to determine the relative position and orientation of the display 102 in relation to the viewer's head 104.

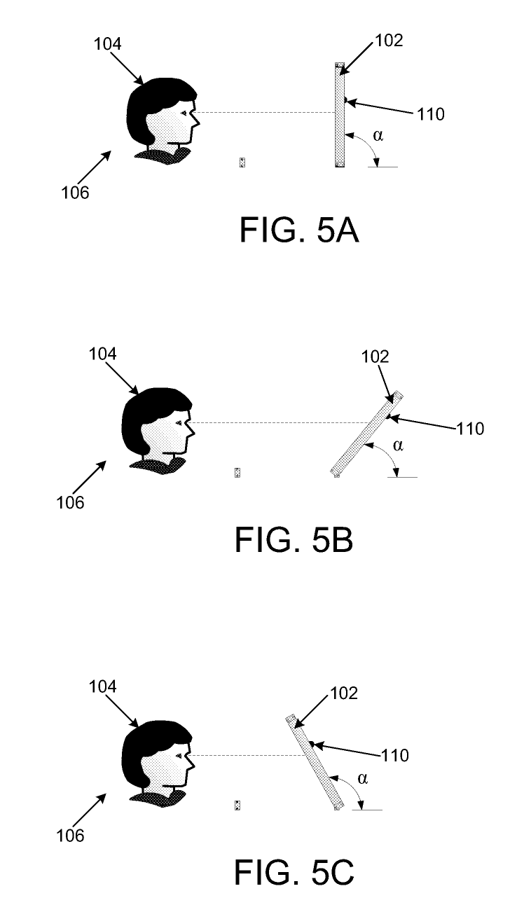

For example, as illustrated in the embodiment shown in FIGS. 4A-4B, a camera 108 may be incorporated into the display 102 to track at least one of the lateral and vertical position of the viewer's head 104, as the viewer's head 104 moves across the display screen 101 from one position in front of the display 102 to another (e.g., from the position shown in FIG. 4A to the position shown in FIG. 4B). Also, as illustrated in the embodiment shown in FIGS. 5A-5C, a position and/or orientation measuring sensor 110 may be incorporated into the display 102, to determine position and/or orientation information of the display 102, such as for example one or more tilt angles of the display 102. The relative position and/or orientation measuring sensor 110 can comprise, for example, at least one of an accelerometer, a compass and even one or a plurality of cameras or other image taking devices, although the position and/or orientation measuring sensor 110 is not limited thereto.

According to one aspect of the invention, the position and/or orientation measuring sensor 110 comprises at least one accelerometer that is capable of measuring the proper acceleration of the display 102 with respect to a local inertial frame to determine an orientation of the display 102, such as for example an angle of vertical tilt a of the display 102 relative to the earth's surface, and/or whether the display 102 is upright or positioned at an angle.

According to yet another aspect, a compass may be included in the position and/or orientation measuring sensor 110 to allow for a determination of the orientation of the display 102 in relation to the earth's magnetic poles. The position and/or orientation measuring sensor 110 can comprise only one of these devices, or alternatively may comprise a plurality of these devices, such as for example a combination of an accelerometer and a compass, which may be provided to allow for the determination of the vertical tilt angle as well as the horizontal orientation of the display 102.

While exemplary embodiments for the determination of the relative position and orientation of the display 102 relative to the viewer 106 have been described above, it should be understood that the invention is not limited to these embodiments. For example, according to one embodiment of the invention, the relative position and orientation of the display 102 may be determined by providing at least two cameras 108 or other image tracking devices that are capable of separately tracking the position of the viewer 106, and triangulating the tracking information to determine the angle and position of the display 102 with respect to a viewer 106.

According to yet another embodiment, an optical flow method can also be used to determine a relative position and orientation of the display, such as by using a camera 108 incorporated into the display 102 to determine a path taken by the display 102 during movement thereof relative to the viewer 106 and/or the environment, such as for example during tilting, raising or lowering, and/or lateral movement of the display 102. Exemplary optical flow methods are described, for example, in the article entitled “Learning Optical Flow” by Sun et al, in D. Forsyth, P. Torr, and A. Zisserman (Eds.): ECCV 2008, Part III, LNCS 5304, pages 83-97, as well as the in the article “Optical Flow Estimation” by Fleet et al, in Mathematical Models in Computer Vision: The Handbook, N. Paragios, Y. Chen and O. Faugeras (Eds.), Chapter 15, Springer, 2005, pages 239-258, which references are hereby incorporated by reference herein in their entireties. Other methods and/or sensors suitable for determining the relative position and orientation of the display 102 in relation to the viewer 106 may also be provided, and aspects of the invention are not limited to the particular embodiments described herein.

The soft proof image is rendered on the display 102 in step S302 based on the relative position and orientation as determined in step S301, to provide a view-dependent rendering of the soft proof image. FIGS. 4A-4B and 5A-5C illustrate aspects of the relation between the relative position and orientation of the display 102 as determined in step S301, to the rendering of the soft proof image in the view-dependent manner in step S302, according to embodiments of the invention. As shown in the embodiment of FIG. 4A, the relative position of the viewer's head 104 is determined by using a camera 108 that tracks the position of the viewer's head 104 across the image. For example, in FIG. 4A, the viewer's head 104 is located in front of the middle of the display screen 101, as shown by the line 201 extending from the camera 108 to the viewer 106. When the viewer 106 moves his/her head 104 to the side of the display screen 101, as in FIG. 4B, the camera 108 is capable of tracking this movement, to update the relative positions of the viewer's head 104 and display 102.

FIGS. 5A-5C demonstrate an embodiment in which a relative orientation of the display 102 is determined by using an accelerometer built into the display 102. According to this embodiment, the display 102 may be capable of determining whether the viewer 106 is viewing the display straight-on (e.g., FIG. 5A), such as for example with the display 102 being substantially vertical, where the tilt angle α between the display and the ground is substantially 90°or whether the viewer 106 has tilted the display either backwards (FIG. 5B) or forwards (FIG. 5C), to yield either a smaller or larger tilt angle α, respectively.

Accordingly, the result of such relative position and/or orientation determination according to this embodiment is that the soft proof image is view-dependently rendered in step S302 with a virtual perspective and/or lighting that corresponds to the determined relative position and orientation in step S301. That is, the perspective and/or lighting on the image may be changed as the viewer 106 moves his/her head 104 to view different areas of the soft proof image, and/or as the viewer tilts and/or changes the angle of the display 102.

For example, in FIGS. 4A-4B, the movement of the viewer's head from the middle of the display 102 to the right side of the display 102 may result in a change in environmental lighting of the soft proof image. That is, the lighting in the soft proof image may shift from the illumination of surfaces and/or objects in an area about the middle of the soft proof image, to the illumination of surfaces and/or objects in an area that is closer to the side of the soft proof image. Thus, according to one aspect, the change in lighting may be as if a light source aligned with the viewer's head 104 were passed across the soft proof image, with those parts of the soft proof image lighting up that correspond to areas positioned across from the viewer's head 104. Thus, movement of the viewer's head 104 may be capable of changing the perspective and/or lighting on the soft proof image as if the soft proof image were being moved with respect to a light source in real life.

In addition, as shown in FIGS. 5A-5C, the tilting of the display 102 with respect to the viewer 106, may change the perspective and/or lighting on the soft proof image as if the soft proof image were being tilted towards or away from the viewer 106 in real life. For example, the tilting of the display 102 away from the viewer 106 (e.g., from the position shown in FIG. 5A to the position shown in FIG. 5B), may make the perspective and/or lighting on the soft proof image appear as if the viewer 106 were viewing the soft proof image from below, for example by lighting surfaces and/or objects in the soft proof image as if a light were shining at an upwardly directed angle at the surfaces and/objects in the soft proof image.

The tilting of the display 102 towards the viewer 106 (e.g., from the position shown in FIG. 5A to the position shown in FIG. 5C), may have the opposite effect, in that it may make the perspective and/or lighting appear as if the viewer 106 were viewing the soft proof image from above, for example by lighting the surfaces and/or objects in the soft proof image as if the light were shining at a downwardly directed angle at the surface and/or objects in the soft proof image. In FIG. 5A, the viewer is viewing the soft proof image straight on, with substantially no tilt, and thus the perspective and/or lighting of the soft proof image may be such that it appears as if a light source were shining directly onto the soft proof image.

Accordingly, the rendering of the soft proof image performed in step S302 provides a view-dependent rendering thereof that is dependent upon the relative position and orientation of the display 102 with respect to the viewer 106, such as for example by rendering with a perspective and/or environmental lighting that is dependent upon the relative position and orientation of the viewer 106. The view dependent rendering may be achieved, for example, by implementing a view dependent rendering algorithm that view-dependently renders the image according to the determined relative position and orientation. Furthermore, the method and apparatus used for view dependent rendering of the soft proof image in step S302 may also be capable of rendering the soft proof image according to perspective and/or lighting schemes other than those particularly described herein. For example, the view-dependent rendering may render the soft proof image with a perspective that is slightly angled even for a viewer 106 that is viewing a soft proof image straight-on, or with a lighting source that is directed from virtual angles other than those particularly described herein.

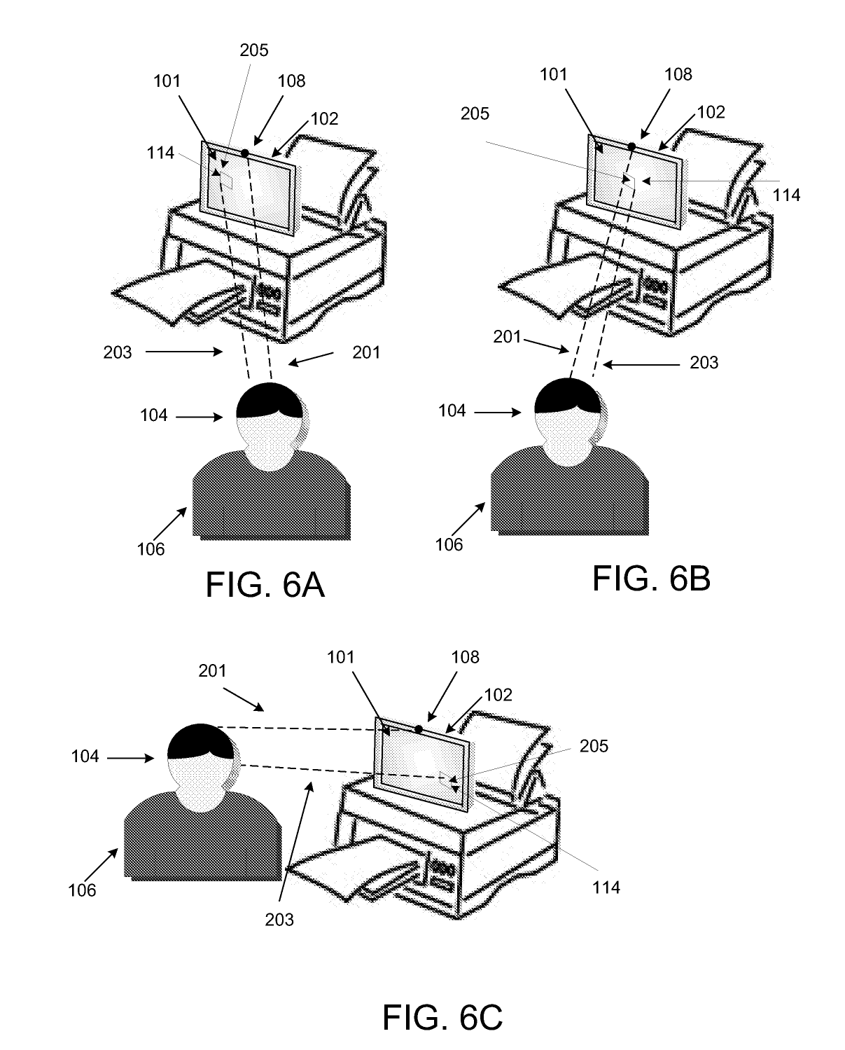

In step S303, the viewer's eye movement relative to the rendered soft proof image is tracked, so that an area 114 that is of interest in the soft proof image to the viewer 106 can be determined in step S304, as shown for example in FIGS. 6A-6C. The area 114 of interest to the viewer 106 may be determined, for example, by identifying an area of the soft proof image as rendered on the display 102 at which the viewer 106 is gazing. For example, the viewer's eye movement may be tracked to determine a line of view 203 from the viewer's eye to a region of the display 102, and to determine an intersection point 205 on the image where the line of view 203 intersects the display screen 101, as shown for example in FIGS. 6A-6C.

The viewer's eye movement may be monitored by using one or more tracking techniques, such as for example by evaluating images of the viewer's eye to determine a change in position of the viewer's pupil, by performing infrared tracking of the viewer's eye, and by tracking eye movement using the bright eye effect, among other suitable techniques. In one embodiment, the viewer's eye movement relative to the soft proof image may be tracked by a camera 108 or other image pickup device, which may be incorporated as a part of the display 102, or may be provided externally therefrom.

An example of a suitable eye movement tracking technology, which may be used to determine an area of interest 114 to a viewer 106 in an image, is described in U.S. Pat. No. 7,068,813 to Lin, which reference is hereby incorporated by reference herein in its entirety. Other examples of technologies that may be suitable for tracking a viewer's eye movement across an image are described in U.S. Pat. No. 7,488,072 to Perlin et al, U.S. Patent Application Publication No. 2008/0297589 to Kurtz et al, U.S. Pat. No. 6,465,262 to Cynthia S. Bell and U.S. Patent Application Publication No. 2008/0137909 to Lee et al, which references are hereby incorporated by reference herein in their entireties.

FIGS. 6A-6C illustrate aspects of such eye movement tracking, according to an embodiment of the invention. In FIG. 6A, the viewer's head 104 is positioned towards the right side of the display 102, and the camera 208 tracks the viewers eye movement as the viewer 106 is gazing at an area of the soft proof image that is located more towards the left of the display 102, as shown by the viewer's line of view 203. In FIG. 6B, the viewer's head 104 remains positioned towards the right side of the display 102, and the camera 108 tracks the viewer's eye movement as the viewer 106 gazes at a more central area of the soft proof image. Finally, in FIG. 6C, the viewer's head 104 is positioned more towards the left side of the display 102, and the camera tracks the viewer's eye movement as the viewer 106 gazes at an area that is more towards the right side of the soft proof image. Thus, the viewer's eye movement may be tracked independently of the relative position and orientation of the viewer 106 in relation to the display 102, in order to allow for determination of the area of interest 114 to the viewer 106 in the soft proof image.

In step S304, the area of interest 114 to the viewer 106 in the soft proof image is determined based on the tracking of the viewer's eye movement performed in step S302. For example, according to one embodiment, a point of intersection 205 where the viewer's line of view 203 intersects the display screen 101 may be determined, and an area of interest 114 corresponding to a region about the point of intersection 205 may be assigned thereto. The particular shape and size of the area of interest 114 may be selected according to parameters that are suitable for viewing the soft proof image, such as for example with respect to the image content as well as with respect to the particular imaging property that is to be adjusted.

In the embodiments illustrated in FIGS. 6A-6C, the area of interest 114 corresponds to a square-shaped region surrounding the point of intersection 205 on the image at which the viewer 106 is determined to be looking. However, the shape selected to define the area of interest 114 can also be other shapes, such as for example circularly shaped, or may be shaped to accommodate a particular feature and/or object in the soft proof image. The area of interest 114 can also be defined to be of a size that is suitable for the subject matter pictured and/or for the adjustment of the one or more particular imaging properties. Also, while embodiments of the invention may provide for only one area of interest 114 to be determined, it may also be possible to determine more than one area of interest in the image to the viewer, for example by determining several areas on the soft proof image that the viewer 106 spends at least a minimum amount of time viewing, and/or by determining one or more areas of the soft proof image that the viewer 106 has repeatedly viewed.

Upon determination of the area of interest 114 in step S304, the imaging property of the area of interest 114 is adjusted in step S305, to provide enhanced viewing of the soft proof image. For example, the imaging property may be automatically adjusted without requiring further input from the viewer 106, once the area of interest 114 has been identified. The imaging property that is adjusted may be one or more of the focus, sharpness, white balance, dynamic range, resolution, brightness and tone mapping in the area of interest 114 in the soft proof image that is rendered in the view-dependent manner. Furthermore, other imaging properties other than those specifically listed herein may also be adjusted.

Adjusting the imaging property in the particular area of interest may allow the viewer 106 to view the soft proof image in a more computationally effective manner, for example by enhancing properties in the particular area of interest 114 with respect to other areas of the soft proof image. The adjustment of the imaging property may also provide a means by which imaging parameters can be set for one or more particular areas to allow for an improved viewing experience thereof, such as a viewing experience that provides more clarity and/or information about structures in the soft proof image, and/or that is more aesthetically pleasing, such as for images based on multidimensional and/or enhanced image data obtained via computational photography techniques.

As an example, the imaging property that is adjusted may be the brightness in the area of interest 114, which brightness may be adjusted to make the particular area more bright in relation to other regions of the view-dependently rendered soft proof image, so as to allow the viewer 106 to more easily view the objects in the particular area. The brightness may also be adjusted to be higher and/or lower to make the area 114 more aesthetically pleasing. As another example, the imaging property that is adjusted may be the resolution in the area of interest 114, which imaging property may be adjusted in the particular area of interest 114 to provide the viewer with more viewable detail in the particular area in comparison to other areas of the soft proof image. Such selective adjustment may allow for computational processing to be focused on the area of interest 114, without requiring processing of adjusting of the entire soft proof image to the predetermined level of adjustment.

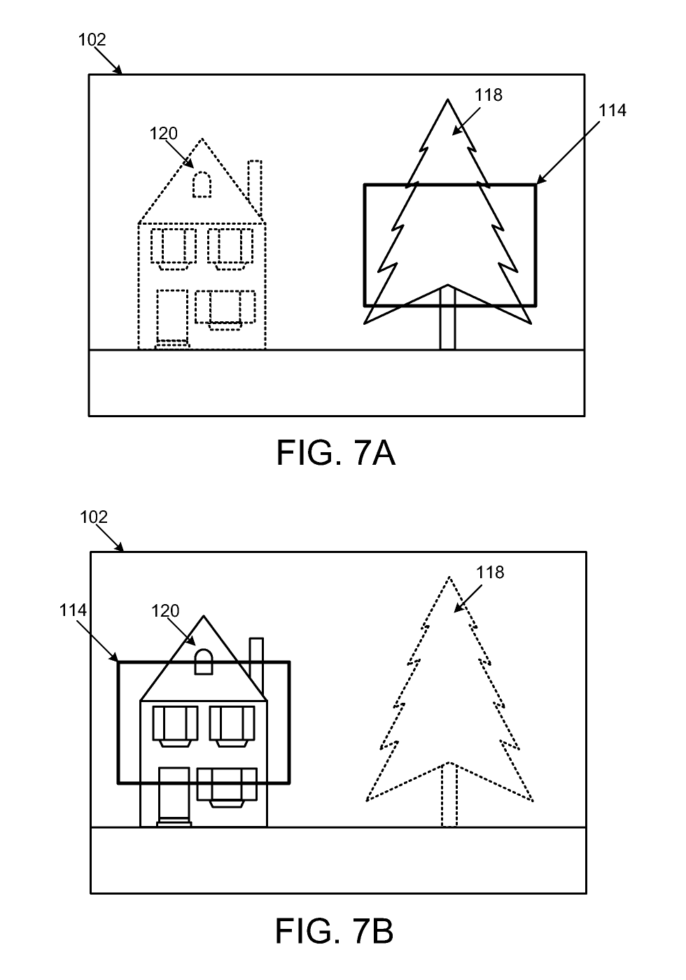

As yet another example, the imaging property that may be adjusted may be the focus of an extended depth of field image. For example, as shown in FIGS. 7A-7B, multidimensional image data may be provided that has focal depths at a number of different focal lengths for different pixel points in an image. That is, the image data may comprise focal depths corresponding to both foreground objects, such as the tree 118 as shown in FIG. 7A, as well as focal depths corresponding to background objects, such as the house 120 shown in FIG. 7B. The image data having the focal depths at a number of different focal lengths may be obtained, for example, by using a camera that is capable of taking extended depth of field images, and/or by calculating focal depths corresponding to focal planes for various objects in the image, as described for example in U.S. Patent Application Publication No. 2008/0131019 to Ng, which reference is hereby incorporated by reference herein in its entirety.

FIGS. 7A-7B illustrate an embodiment of such automatic adjustment of the focus for an area of interest 114 in the soft proof image to the viewer 106, according to aspects of the invention. According to this embodiment, the automatic focus adjustment may occur such that when the viewer 106 gazes at an area in the soft proof image that includes an object located in the foreground of the soft proof image, such as the tree 118, the area of interest 114 is determined to include the tree 118, and the focus of the area of interest 114 is adjusted to bring the tree 118 into focus, while other portions of the soft proof image may be allowed to lapse out of focus.

On the other hand, if the viewer 106 switches his/her gaze to an object located in the background of the soft proof image, such as the house 120, the area of interest 114 is determined to include the house 120, and the focus of the area of interest 114 is adjusted to bring the house into focus, while other parts of the soft proof image, such as the tree 118, may be allowed to at least partially defocus. Alternatively, both the house and the tree may be brought into focus by having the viewer view and “select” each region, such as for example by gazing at the region for a predetermined minimum amount of time.

By allowing for selective focus of one or more areas of interest 114 in the soft proof image, it may be possible for a viewer 106 to view a soft proof image rendered in a view dependent manner, and in particular to view areas of interest 114 in the soft proof image, without requiring the excessive computational effort that might otherwise be needed to view the entire soft proof image and/or larger portions of the soft proof image with the adjusted focus level. The selective adjustment of the focus may also be particularly advantageous, for example, in the viewing of multidimensional image data that includes data capturing multiple different angles of a real scene, and/or that is a composite of multiple different images taken from different angles of a real scene, as it could be otherwise difficult to determine an appropriate region of the image on which to focus based on the image data alone.

Thus, according to aspects of the invention, the focus for an area of interest 114 in the soft proof image can be determined in tandem with suitable view-dependent rendering parameters. Aspects of the invention may therefore allow for the viewing of multidimensional data having extended depth of field information, including data that corresponds to a real scene, in a continuously updated, view-dependent manner.

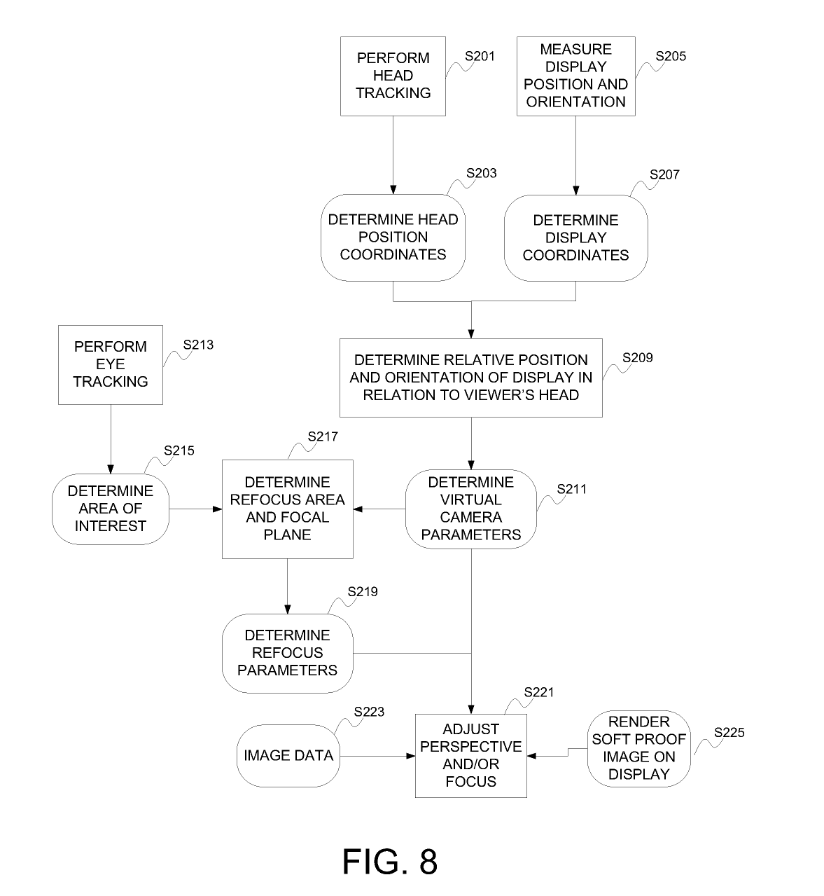

FIG. 8 is a flow chart illustrating an embodiment of a display method in which automatic focusing of an area of interest 114 to a viewer 106 in an extended depth of field image is provided in a view-dependently rendered manner. According to this embodiment, a multidimensional data set comprising image data corresponding to captured light field images, and including extended depth of field information, is provided for rendering on the display 102 (step S223). One or more of the perspective (e.g., the virtual perspective and/or lighting) and the focus of the image may be continuously and/or automatically adjusted (step S221) to provide a displayed soft proof image that is view-dependently rendered (step S225). The focus is adjusted to a predetermined level for the area 114 of the soft proof image that is determined to be of interest to the viewer 106. The parameters for determining the adjustment of the perspective and/or focus in step S221 can be obtained by performing steps S201-S219, as also shown in the embodiment.

According to the embodiment as shown, the position of the viewer's head 104 is tracked (step S201), and the viewer's head position coordinates are determined based on the tracking information (step S203). The position and orientation of the display 102 is also measured (step S205), and the coordinates of the display 102 are determined based on the measured position and orientation (step 207). The head position coordinates determined in step S203, as well as the display coordinates as determined in step S207, are then correlated with one another to determine the relative position and orientation of the display 102 in relation to the viewer's head 104 (step S209). The relative position and orientation are then used to determine virtual camera parameters (step S211), such as lighting and perspective parameters, that are suitable for view-dependent rendering of the soft proof image, for example by using a view dependent rendering algorithm based on the determined relative position and orientation determined in step S209.

Simultaneously with one or more of the view-dependent rendering steps S201-S211, the viewer's eye movement relative to the rendered soft proof image is tracked (step S213), such that an area of interest 114 to the viewer 106 in the rendered soft proof image can be determined (step S215). The area of interest 114 to the viewer 106 in the soft proof image as determined in step S215, as well as the virtual camera parameters determined in step S211, are used to determine a refocus area and a refocus plane for the area of interest 114 (step S217). It can be appreciated that the virtual camera parameters determined in step S211 may be used as input in the determination of the focal plane and refocus area in step S217, by providing perspective information for the area of interest 114. The refocus area and focal plane as determined in step S217 can be used to determined refocus parameters for the particular area of interest (step S219), for example by referring to focus parameters that have been previously stored for the particular refocus area and focal plane, or by calculating suitable refocus parameters, as well as by other means. The refocus parameters determined in step S219 for the particular area of interest 114, as well as the virtual camera parameters determined in step S211, are used as input for the adjustment in the perspective and/or focus of the image (step S221).

For example, the adjustment of the perspective and/or focus as in step S221 may be performed by implementing an algorithm capable of calculating a corresponding adjustment to the perspective and/or focus of the image based on the refocus parameters determined in step S219 and the virtual camera parameters determined in step S211. A view-dependent rendering of the soft proof image with extended depth of field focusing for a particular area of interest 114 in the image can thus be provided (step S223), based on the adjustment of the perspective and/or focus of the soft proof image. Any one or more of the steps S201-S221 and steps S213-S221 can be repeated to provide continuous updating and refocusing of the soft proof image according to a change in relative position and/or orientation of the display 102 with respect to the viewer 106, as well as according to any change in the area of interest 114 in the soft proof image that is being gazed at by the viewer 106.

According to an embodiment of the invention, a particular view of the soft proof image as rendered on the display 102 may be selected, and continuous view-dependent rendering of the soft proof image may be suspended, such that the selected view is “frozen” on the display screen 101. A particular image view may be selected, for example, because it clearly shows aspects of the imaged subject matter that are of interest, for optimum display with the adjusted imaging property, and/or for aesthetic purposes. Once the particular view is selected, one or more of the parameters and/or properties used in rendering the selected view, such as for example one or more of the view-dependent rendering parameters, as well as the adjusted imaging property for the at least one area of interest, may be stored on a storage medium for future use. The stored parameters and/or properties can be used in the display of a subsequent image, or for re-display of the same image, in accordance with the selected view.

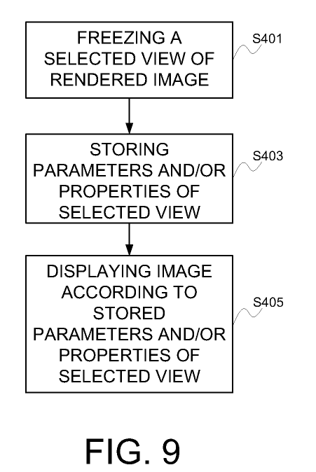

FIG. 9 is a flow chart illustrating an embodiment of a method for storing parameters and/or properties for rendering a display of an image according to a selected view. In the embodiment as shown, the method comprises freezing a selected view of the soft proof image that is view-dependently rendered on the display 102 (step S401). The selected view corresponds to a view of the soft proof image as rendered according to one or more image rendering parameters determined for the relative position and orientation of the display 102, and at least one imaging property that has been adjusted for the at least one area of interest 114.

For example, the selected view may comprise a view of the soft proof image that corresponds to a particular perspective and/or lighting of the soft proof image as rendered by the view-dependent rendering process, as well as the adjusted level of the imaging property, e.g. the focus, in the area of interest 114. The particular view may be selected, for example, via viewer input to the display 102 and/or apparatus 100 comprising the display 102.

For example, methods by which the viewer 106 may select the particular view as displayed on the display screen 101 can include, but are not limited to, indicating selection via a button, keyboard, mouse, or other peripheral device, touching the display screen 101, speaking a voice command, indicating via a gesture captured by the camera 108, and/or by viewing the particular view of the soft proof image for a predetermined period of time. Display of the soft proof image is “frozen” upon selection of the particular view, such that any changes and/or updating in the soft proof image rendering is suspended and/or halted, resulting in a static display of the soft proof image in accordance with the parameters and/or properties associated with the particular view.

Following selection of the soft proof image view, one or more of the image rendering parameters and the adjusted imaging property corresponding to the selected view are stored in a storage medium (step S403). For example, one or more view-dependent rendering parameters that render the soft proof image according to the selected view, such as for example lighting parameters and/or perspective parameters, may be saved to the storage medium. Also, the value of the adjusted imaging property for the at least one area of interest 114 may be saved to the storage medium, and values for a plurality of imaging properties and/or a plurality of areas of interest 114 may also be saved. In one embodiment, all of the view-dependent parameters and imaging properties used to render the soft proof image according to the selected view may be stored in the storage medium.

According to another embodiment, only the view-dependent rendering properties may be saved to the storage medium, without saving the value of the adjusted, or alternatively the value of the adjusted imaging property can be saved without saving view-dependent rendering properties, according to the preferences of the viewer 106. The values of the parameters and/or properties may be stored on a storage medium that is located, for example, in the display 102 itself, in an apparatus 100 comprising the display 102, or at a location that is remote from the display 102 and/or the apparatus 100.

According to one aspect, the storage medium comprises a disk 3 that is provided as a part of the apparatus 100 comprising the display 102. The parameter and/or imaging property values may also be stored together with the image data on the storage medium, or alternatively the parameter and/or imaging property values may be stored separately therefrom.

A soft proof image may be re-displayed on the display 102, or a subsequent soft proof image may be newly displayed on the display 102, by rendering the soft proof image according to one or more of the rendering parameters and/or adjusted imaging properties that have been stored in the storage medium for the selected view (S405). That is, the soft proof image is rendered on the display 102 by applying the previously stored parameters and/or properties to the image data, such that the soft proof image is displayed according to the previously selected view. For example, the soft proof image can be rendered according to one or more view-dependent rendering parameters, e.g., one or more of a perspective and/or lighting, and/or one or more imaging properties, e.g., a focus of an area of interest 114, corresponding to those stored for the previously selected view.

According to one aspect, the display of the soft proof image as rendered according to the stored rendering parameters and/or adjusted imaging properties may comprise a static rendering of the soft proof image according to the selected view. That is, the image may be displayed without changing in accordance with movement in the relative position and/or orientation of the display 102, and/or without updating in accordance with a change in the area of interest 114 to the viewer 106.

Alternatively, the display of the soft proof image according to the stored rendering parameters and/or adjusted imaging properties may correspond to a starting point and/or initial view of the soft proof image, which initial view may then be subsequently updated. The initial view can be updated, for example, in accordance with a change in relative movement and/or orientation of the display, or a change in a viewer's area of interest 114, to provide view-dependent rendering of the soft proof image and/or adjustment of the imaging property in the area of interest 114. The initial view of the soft proof image may also be statically displayed for a period of time prior to updating of the soft proof image.

According to one aspect, the rendered soft proof image corresponds to the same image as that for which the rendering parameters and/or adjusted imaging properties were previously stored, resulting in the display of the same view of the soft proof image that was previously selected. The viewer 106 may thus be able to re-display the soft proof image on the display 102 according to the selected view, without requiring further adjustment in the image rendering parameters and/or properties to reproduce the previously selected view. That is, the soft proof image may be re-displayed without requiring, e.g., adjustment of the relative position and/or orientation of the display 102, and/or adjustment in the level of the imaging property of the area of interest 114. Thus, once the viewer chooses a particular view of a soft proof image view-dependently rendered on the display 102, the viewer may be able to repeatedly re-load and automatically render the soft proof image according to the previously selected view.

As described above, the image data that is view-dependently rendered with adjustment of the imagining property in the area of interest 114, may be image data that has been obtained by a computational photography method. For example, according to one aspect, the computational photography technique used to prepare the image data may be a technique that uses a computational camera, which may be a camera that is capable of taking multiple images of the same scene with varying parameters, such as for example different exposure, focus, aperture, view, illumination and/or time of capture. A final image may then be reconstructed by selecting values from these multiple different images. As another example, the computational camera used to prepare the image data may be one that is capable of taking a single image of a scene as an encoded representation thereof, which encoded image data may itself appear distorted, but that can be decoded to provide information about the scene.

An example of a computational camera suitable for preparing image data according to aspects of the invention may be a plenoptic camera, as described for example in the article entitled “Single Lens Stereo with a Plenoptic Camera” by Adleson et al. in IEEE Transactions on Pattern Analysis and Machine Intelligence, Vol. 14, No. 2, February 1992, pages 99-106, which article is hereby incorporated by reference in its entirety herein. The plenoptic camera of Adleson et al. may be capable of taking image data of a scene that includes information about how the scene would look when viewed from a continuum of different viewpoints.

Computational photography techniques may also comprise techniques that combine data from multiple different views of the same scene, to allow for re-construction of the scene from different viewpoints. For example, computational photography techniques may be applied to extract image information from databases of photos, and compute viewpoints for each photo for a particular scene, from which a viewable 3D model of the scene may be re-constructed. In yet another computational photography technique, 3D image data for a scene may be obtained by analyzing one or more 2D images of the scene for certain features, such as image depth cues and relationships between different objects in an image, from which the 3D image may be computed. As another example, a 2D to 3D conversion of image data may be provided by using a pop-up type algorithm that determines where the “ground” in an image meets the “sky,” to evaluate which objects in an image should be “popped-up” against the image horizon. Other suitable computational photography methods may include, for example, techniques for capturing lightfield images that contain the full 4D radiance of a scene, which methods can be used to reconstruct correct perspectives for viewpoints other than those present in the original image capture array.

Thus, the image data provided by the computational photography techniques described herein, as well as by computational photography techniques that are other than those specifically described herein, can be used to provide the image data that may be view-dependently rendered as a soft proof image on the display 102 with imaging property adjustment, according to aspects of the invention. Also, image data that is obtained from methods that do not fall within the realm of those understood to correspond to computational photography techniques, may also be used to provide image data for rendering on the display 102 in accordance with aspects of the invention.

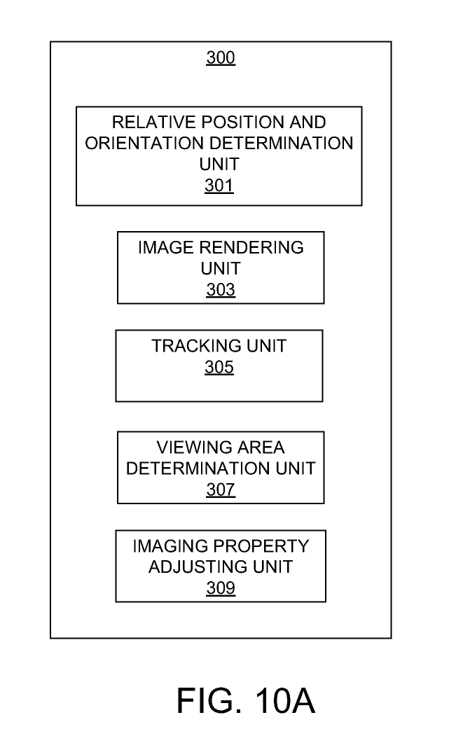

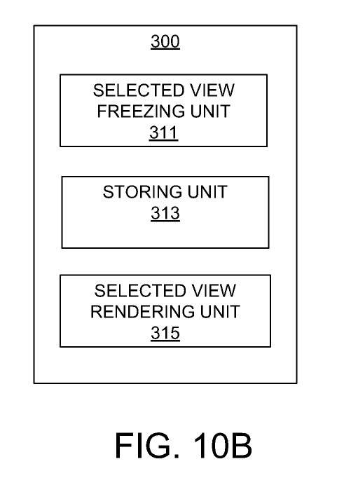

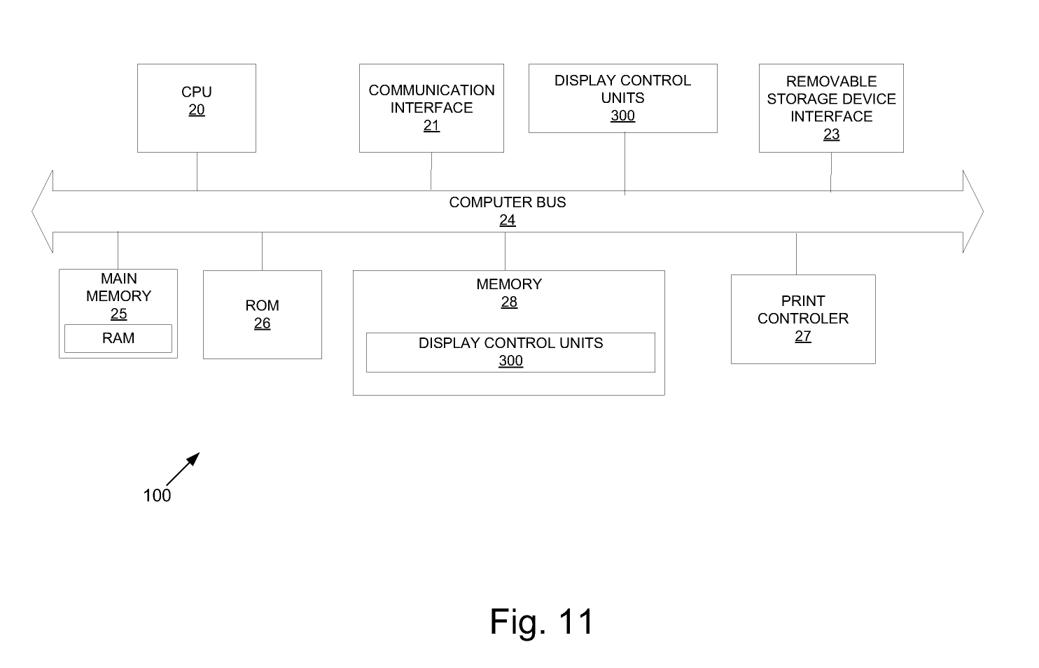

According to one embodiment, functions according to aspects of the invention may be achieved by providing an apparatus 100 comprising the display 102, which apparatus also comprises at least one processor 20 that is programmed to control one or more display control units 300 to provide for rendering and updating of the image on the display 102. FIGS. 10A-10B and 11 illustrate embodiments of such display control units 300 and the internal architecture of an apparatus having the display control units 300. According to the embodiment as shown in FIG. 10A, the display control units 300 may generally be capable of performing the functions described above in relation to steps S301-S305 in the flow chart of FIG. 3.

That is, the display control units 300 may comprise one or more of: a relative position and orientation determination unit 301 for determining a relative position and orientation of the display 102 in relation to a viewer's head 104; an image rendering unit 303 for rendering the image on the display 102 based on the relative position and orientation; a tracking unit 305 for tracking the viewer's eye movement relative to the rendered image; viewing area determination unit 307 for determining at least one area of interest 114 in the image to the viewer 106 based on the viewer's eye movement; and an imaging property adjusting unit 309 for adjusting an imaging property of the at least one area of interest 114.

According to the embodiment as shown in FIG. 10B, the display control units 300 may also be generally capable of performing the functions described above in relation to steps S401-S405 of FIG. 9. That is, the display control units 300 may comprise one or more of: a selected view freezing unit 311 for freezing a selected view of the image rendered on the display, the selected view corresponding to the image as rendered according to one or more image rendering parameters determined for the relative position and orientation of the display, and the imaging property adjusted for the at least one area of interest; a storing unit 313 for storing, in a storage medium, one or more of the image rendering parameters and the adjusted imaging property corresponding to the selected image view; and a selected view rendering unit 315 for either re-displaying the image or displaying a subsequent image on the display, by rendering on the display according to the rendering parameters and adjusted imaging property stored for the selected view.

FIG. 11 is a block diagram of a portion of the internal architecture of an embodiment of an apparatus 100 having the display 102 that is configured to display a soft proof of an image thereon and print the image according to aspects of the invention. It should be understood that aspects of the invention are not limited to the particular embodiment as shown in FIGS. 10A-10B and 11, and other apparatuses and/or internal architectures, other than those described herein, may also be suitable for displaying the soft proof of an image and printing the image in accordance with aspects of the invention.

Shown in FIG. 11 is a processor such as a CPU 20, which can be for example any type of microprocessor, and which is coupled via a bus 24 to other hardware components, such as a memory 25. Also, interfacing with bus 24 is a communication interface 21 that allows the apparatus 100 to communicate with an external device, such as a host computer (not shown), a removable storage device interface 23 that enables communication between the apparatus 100, a removable storage device, such as for example a flash drive, secure digital card, etc., and a print controller 27 which controls printing functions of the apparatus.

The internal architecture of the apparatus 100 may further comprise a read only memory (ROM) 26 that stores invariant computer-executable process steps for basic system functions such as basic I/O, start-up, etc. Main random access memory (RAM) 25 can provide CPU 20 with memory storage that can be accessed quickly to control and/or operate software/firmware programs and/or applications therewith.

Also shown in FIG. 11 is memory 28, that may be configured, for example, to store computer-executable instructions, such as in the form of program code, that can be read out and executed by a processor to perform functions corresponding to those performed by the display control units 300, as well as other functions performed by the apparatus 100 as described herein. FIG. 11 illustrates the memory 28 as having the display control units 300 stored thereon.

According to an exemplary embodiment, at least one processor provided as a part of the information processing apparatus 100, such as the CPU 20, is programmed to execute processing so as to control and/or operate one or more of the units and/or applications of the apparatus 100 as described herein, such as for example one or more of the relative position and orientation determining unit 301, the image rendering unit 303, the tracking unit 305, the viewing area determination unit 307 and the imaging property adjustment unit 309, such that rendering and updating of the image on the display 102 according to aspects of the invention can be achieved.

In such a case, the program and the associated data may be supplied to the apparatus 100 using a storage medium such as, but not limited to, a flash memory or an external storage medium via a network or direct connection. In this way, the storage medium may store the software program code that achieves functions according to aspects of the above-described exemplary embodiments. Aspects of the present invention may thus be achieved by causing the processor 20 (such as a central processing unit (CPU) or micro-processing unit (MPU)) of the apparatus 100 to read and execute the software program code, so as to provide control and/or operation of one or more of the units and/or applications described herein.

In such a case, the program code read out of the storage medium may realize functions according to aspects of the above-described embodiments. Therefore, the storage medium storing the program code can also realize aspects according to the present invention.

While aspects of the present invention have been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A method for printing an image, the method comprising:
selecting an image to be printed;
determining a relative position and orientation of a display in relation to a user's head;
rendering the selected image for display based on the relative position and orientation;
displaying the rendered image, wherein the displayed rendered image is a representation of what the rendered image will look like when printed;
tracking the user's eye movement relative to the rendered image;
determining at least one area of interest in the image to the user based on the user's eye movement;
adjusting at least one imaging property of the at least one area of interest;
rendering an image for printing based on adjusting the at least one imaging property; and
printing the image.

2. The method according to claim 1, wherein the image rendered based on adjusting the at least one imaging property is displayed prior to printing.

3. The method according to claim 1, wherein the display is separate from an image forming device which prints the image.

4. The method according to claim 1, the display is integrated on an image forming apparatus that prints the image.

5. The method according to claim 1, wherein adjusting the imaging property of the at least one area of interest comprises adjusting at least one of the focus, sharpness, white balance, dynamic range, resolution, brightness and tone mapping of the area of interest.

6. The method according to claim 1, wherein the relative position and orientation of the display is determined using at least one camera to track a face of the viewer.

7. The method according to claim 1, wherein the relative position and orientation of the display is determined using at least one relative position and/or orientation measuring sensor.

8. The method according to claim 7, wherein the at least one relative position and/or orientation measuring sensor comprises at least one accelerometer.

9. The method according to claim 8, wherein the at least one relative position and/or orientation measuring sensor further comprises a compass.

10. The method according to claim 6, wherein the relative position and orientation of the display is determined using an optical flow method.

11. The method according to claim 6, wherein the relative position and orientation of the display is determined by using at least two cameras.

12. The method according to claim 1, wherein rendering of the image based on the determined relative position and orientation thereof comprises rendering the image with parameters selected to provide a virtual perspective of the image that corresponds to the determined relative position and orientation.

13. The method according to claim 1, wherein the viewer's eye movement relative to the rendered image is tracked using a camera.

14. The method according to claim 1, wherein the at least one area of interest to the viewer in the image is determined based on an identification of an area of the image that the viewer is gazing at.

15. The method according to claim 1, comprising automatically repeating at least one of: the determining of the relative position and orientation of the display in relation to the viewer's head; the rendering of the image based on the relative position and orientation; the tracking of the viewer's eye movement relative to the rendered image; the determining of the at least one area of interest in the image to the viewer based on the viewer's eye movement; and the adjusting of the imaging property of the at least one area of interest, to continuously update rendering of the image on the display.

16. The method according to claim 1, wherein the image is formed from image data of a real scene captured by an image capturing device.

17. The method according to claim 1, further comprising:
freezing a selected view of the image rendered on the display, the selected view corresponding to the image as rendered according to one or more image rendering parameters determined for the relative position and orientation of the display, and the imaging property adjusted for the at least one area of interest;
storing, in a storage medium, one or more of the image rendering parameters and the adjusted imaging property corresponding to the selected image view; and
either re-displaying the image or displaying a subsequent image on the display, by rendering on the display according to the rendering parameters and adjusted imaging property stored for the selected view.

18. A computer readable medium having stored thereon computer executable instructions for displaying an image on a display according to the method of claim 1.

19. An apparatus for printing an image, the apparatus comprising:
a display configured to display an image selected to be printed; and
at least one processor coupled via a bus to a memory, the processor being programmed to control one or more of:
a relative position and orientation determining unit configured to determine a relative position and orientation of the display in relation to a user's head;
an image rendering unit configured to render the image on the display based on the relative position and orientation, wherein the rendered image being displayed is a representation of what the rendered image will look like when printed;
a tracking unit configured to track the user's eye movement relative to the rendered image;
a viewing area determination configured to determine at least one area of interest in the image to the user based on the user's eye movement; and
an imaging property adjusting unit configured to adjust at least one imaging property of the at least one area of interest, wherein the image rendering unit renders an image for printing based on adjusting the at least one imaging property; and
a print controller configured to print the image.

20. The apparatus according to claim 19, wherein the image rendered based on adjusting the at least one imaging property is displayed prior to printing.

21. The apparatus according to claim 19, wherein the display is separate from the apparatus.

22. The apparatus according to claim 19, wherein adjusting the imaging property comprises adjusting at least one of the focus, sharpness, white balance, dynamic range, resolution, brightness and tone mapping of the at least one area of interest.

23. The apparatus according to claim 22, wherein the imaging property adjusting unit is configured to adjust the focus of the at least one area of interest.

24. The apparatus according to claim 19 further comprising at least one camera, wherein the relative position and orientation determination unit is configured to determine the relative position and orientation of the display by using the camera to track a face of the user.

25. The apparatus according to claim 24 further comprising at least one relative position and/or orientation measuring sensor, wherein the relative position and orientation determination unit is configured to determine the relative position and orientation of the display by using the at least one relative position and/or orientation measuring sensor.

26. The apparatus according to claim 25, wherein the at least one relative position and/or orientation measuring sensor comprises at least one accelerometer.

27. The apparatus according to claim 26, wherein the at least one relative position and/or orientation measuring sensor further comprises a compass.

28. The apparatus according to claim 24, wherein the relative position and orientation determination unit is configured to determine the relative position and orientation of the display using an optical flow method.

29. The apparatus according to claim 24 further comprising at least two cameras, wherein the relative position and orientation determination unit is configured to determine the relative position and orientation of the display by using the at least two cameras.

30. The apparatus according to claim 19 further comprising a camera, wherein the tracking unit is configured to track the viewer's eye movement relative to the rendered image using the camera.

31. The apparatus according to claim 19, further comprising:
a selected view freezing unit for freezing a selected view of the image rendered on the display, the selected view corresponding to the image as rendered according to one or more image rendering parameters determined for the relative position and orientation of the display, and the imaging property adjusted for the at least one area of interest;
a storing unit for storing, in a storage medium, one or more of the image rendering parameters and the adjusted imaging property corresponding to the selected image view; and
a selected view rendering unit for either re-displaying the image or displaying a subsequent image on the display, by rendering on the display according to the rendering parameters and adjusted imaging property stored for the selected view.
